(19) United States
(12) Patent Application Publication
(10) Pub. No.: US 2022/0164871 A1
(43) Pub. Date: May 26, 2022

(54) Forms Of Loan Collaterals For Municipalities

(71) Applicant: Gustas Mavroudis, HICKSVILLE, NY (US)

(72) Inventor: Gustas Mavroudis, HICKSVILLE, NY (US)

(21) Appl. No.: 17/100,918

(22) Filed: Nov. 22, 2020

(51) Int. Cl. G06Q 40/02; G06Q 50/26

(52) U.S. Cl. CPC G06Q 40/025; G06Q 50/26

(57) ABSTRACT

Specially structured forms of collateral designed to enhance the ability of lenders to be able to provide secured loans to municipalities to protect the interest and principal payments to the lender in the event of a default of the debt by a municipality and collateral forms detailed here are also applicable to any type of governmental structures including states and national countries.

### BACKGROUND

Municipalities and other forms of governmental structures such as states and national countries generally are funded through specially structured bonds, tax revenue and by borrowing funds. We are addressing the complex issue of how collateral can be used for loans and other funding that is made available for municipalities.

We are presenting a number of unique and new forms of collateral and how this collateral can be structured and applied to loans for municipalities. We present in detail with steps the techniques to be used to apply these forms of collateral to loans or other forms of debt for municipalities which are not known or currently available.

Attached are also patent searches to show that no other patent results exist for what we are now presenting.

### DETAILED DESCRIPTION OF THE INVENTION

### Type A: Collateral Transformation of Property to Lease Holdings

In this scenario we examine the use of a loan or debt which can be through a corporation, individual or a banking institution that provides a loan to a municipality. Because of various local and state governmental mandates it may be that specific parcels of property that are owned by a municipality may not be used directly as collateral for the funding source. We introduce a new structure for the usage of public property as a collateral in this situation.

Given a loan which we call Debt A to a particular municipality a specified public property is attached to the Debt A to be used as a type of collateral which we are labeling “Para-Collateral.”

Para-Collateral is defined as a type of collateral which transforms to a leasehold structure upon the default of a debt or funding source by a municipality.

In the event of a default the issuer of the debt or source of funding has the legal right to utilize the public property that was structured in the form of Para-Collateral to the debt by being granted a pre-agreed to lease and lease amounts. The municipality defines in the loan agreement what uses can be allowed on the leased property after it is transferred to the lender in the event of a default of the loan by a municipality

For example, if the Para-Collateral was a beach area, the issuer of the defaulted debt or loan may be able now to charge a fee for usage of the beach area and introduce food sources such as a restaurant. The lease would be for a period of time such as 50 years with renewable provisions. Thus, in this situation although the municipality or governmental source still owns the property the issuer of the defaulted debt or funding source is able to protect the loss of revenue from the defaulted debt with the use of the Para-Collateral.

The Para-Collateral should still be valid even in the event that the municipality files Chapter 9 Bankruptcy by appropriate legal pre-agreements between the issuer of the debt or funding source and the municipality.

### Metes and Bounds

The Metes and Bounds of using a form of monetary collateral entitled Para-Collateral is defined as a type of collateral which transforms to a leasehold structure upon the default of a debt or funding source by a municipality.

Since the concept of this form of Collateral is to replace direct physical collateral with the transformation of the physical collateral to leasehold in this situation the Metes and Bounds would be the entire contour of the loan to the municipality by the lender or in numerical format 100% of the entire loan amount.

Further the boundaries of the contour that determines the structure of the collateral that is being described as Para-Collateral in terms of the applicable Metes and Bounds would be mathematically equivalent to the total amount of periodic interest and principal being paid for the loan.

### Steps for Type A: Para-Collateral Structure

1. Attach selected property or revenue producing entity of municipality to a specific designated loan in the original loan agreement.
2. In loan agreement with municipality regarding designated attached property to loan agreement the property has a lease attached which transfers to the lender upon default of the loan by the municipality.
3. The lease allows the lender to charge fees and other charges as it relates to the property attached to the lease with the intent to replace the interest and principal payments that was obligated to be paid by the municipality to the lender.
4. The terms of the lease is for a finite period of time and is renewable.

### Type B-Public Property Structured as Dominion Collateral

In this scenario we have a loan or other form of funding being issued to a municipality by a private source such as an individual, bank, or other entity. The municipality issues a form of collateral with the loan which we are labeling as “Dominion-Collateral.” We define Dominium-Collateral as the special placement of selected public properties and other municipal entities into corporate structures which are then to be used as agreed to collateral for a loan. In this situation the corporations being used are pre-agreed to be exempt from being a part of Chapter 9 Bankruptcy filings or other forms of default that a municipality may seek to utilize in a Plan of Adjustment as filed under Chapter 9 Bankruptcy.

The corporate structure is transferred to the lender of funds to the municipality while the public property that has been placed into the corporate structure is still owned by the municipality under Dominion Collateral.

An example of Dominion Collateral could be a municipal parking lot which upon the default of a municipality for a loan from an entity transfers the corporation that contains the parking lot to the entity that made the loan with rights and privileges regarding the parking lot being transferred to the entity.

In this situation, for example, the private entity may now charge fees for parking that are paid through the corporation to the lending entity as partial compensation for non-payment of principal and interest to the lender because of the default by the municipality.

The use of a corporation in this situation creates a flow through of revenue from the public property to the lending entity while the municipality or other governmental structure still legally owns the public property.

Here we note the difference between a leasehold form of collateral through Para-Collateral and collateral as being Dominion-Collateral in that Dominion-Collateral is not a lease. In a Dominion-Collateral situation the municipality or other governmental structure while still legally owning the public property has forfeited for perpetual time any cash flow that the public property generates or may generate.

### Metes and Bounds

The Metes and Bounds of using this form of monetary collateral is based on the issuance of a form of collateral with the loan which we are entitled “Dominion-Collateral.” We define Dominium-Collateral as the special placement of selected public properties and other municipal entities into corporate structures which are then to be used as agreed to collateral for a loan to the municipality. In this situation the corporations being used are pre-agreed to be exempt from being a part of Chapter 9 Bankruptcy filings or other forms of default that a municipality may seek to utilize in a Plan of Adjustment as filed under Chapter 9 Bankruptcy.

The Metes and Bounds of this form of Collateral should be structured to include as an economic contour the entire scope of the loan amount as various structures of collateral are placed by the municipality into a special holding corporation that would have a pre-agreement between the municipality and the lender to be exempt from being listed as non-excludable debt in the event of a Chapter 9 Bankruptcy filing by the municipality

### Steps for Type B: Dominion Collateral

1. Selected public properties and other public entities with either cash flow or potential for cash flow are placed into special corporation structures which have been pre-selected and indicated in the loan agreement between the lender and the municipality.
2. Upon default of a loan between the lender and the municipality the ownership of the special corporations are transferred to the lender.
3. The lender can now charge fees and other amounts as they relate to the properties in the special corporations to recapture loss interest and principal payment revenue as a result of the default of the municipality to the loan that was made with the lender.
4. The transfer of ownership in Dominion Collateral to the lender is permanent and not subject to a time limitation.

### Type C: Reverse Usage Bond (RUB)

This is a new form of Bond that can be used when a private lender provides funding for a municipality or government structure. The Reverse Usage Bond (RUB) is a form of bond that is self-funding and pays for the cost of a credit line through the structure of the bond. In RUB the municipality sets up a line of credit with the lender's funds and then places the remaining lent funds into a special bond which we call a Reverse Usage Bond (RUB). The RUB bond is then sold for a 5 year period of time by which the municipality obtains the interest and principal to be able to pay back the funds borrowed from the lender in 5 years. We note that the 5 year period of time is flexible and can be less or more such as 3 years, 10 years or other time structures.

We further illustrate the structure of a RUB form of Bond by example:
A. Private lender distributes $30 million dollar loan to a municipality.
B. The municipality now utilizes this amount as follows:
   (1) The municipality establishes a $5 million dollar line of credit to be used for designated purposes.
   (2) The balance of $25 million dollars from the loan is structured as a Bond which the municipality will sell to a municipality with A or better credit rating for a 5 year term.
   (3) At the end of 5 years the municipality returns the original amount that was borrowed which was in this example $30 million dollars with a 25% (or other agreed to amount) interest included in the repayment amount to the lender.

The structure of a RUB Bond allows a municipality the ability to borrow funds at a low rate through utilizing the special RUB Bond Structure. The RUB Bond is a new structure for municipal bonding that is not currently being utilized.

### Metes and Bounds

The metes and bounds of using a form of monetary collateral based on the issuance of a special Bond which we label The Reverse Usage Bond (RUB) is a form of bond that is self-funding and pays for the cost of a credit line through the structure of the bond. In RUB the municipality sets up a line of credit with the lender's funds and then places the remaining lent funds into a special bond which is the Reverse Usage Bond (RUB).

In this situation the boundary pf the Metes and Bounds is considered to be the Contour established by the entire amount of principal and life time total interest of the loan established by the lender. In this form of collateral the boundary of the Metes and Bounds would be considered the interior of the area that is created by the boundary which in this case would be an area approximately equal to the historical total of principal and interest.

### Steps for Type C: Reverse Usage Bond (RUB)

1. A special Bond called a Reverse usage Bond (RUB) is applied for approval by the municipality to the appropriate state/federal officials.
2. Upon approval of the Reverse Usage Bond (RUB) the loan from the lender to the municipality is to be used as collateral for the loan.
3. Once the loan is activated between the lender and the municipality the funds from the Reverse Usage Loan are transferred from the lender to the municipality.
4. The municipality now structures with part of the funding from the lender a line of credit which can be used for expenses or other purpose payments by the municipality.
5. The balance of the funds from the lender are now structured as a special Bond that can be sold to a A or greater rating rated state or municipality for a five year term.
6. At the end of the 5 year term of the bond the municipality returns the funds to the lender with a fixed additional variable amount such as 25%.

### Type D: Direct Application Funding (DAF)

Direct Application Funding (DAF) is a continuous stream of designated sources of municipal cash flow as collateral for a loan. Direct Application Funding (DAF) is based upon the operating budget of a municipality or governmental structure.

DAF is structured to match line of credits for specific operating budget items. The combined line of credits lead to a primary line of credit which summates the ancillary line of credits being offered. In this situation the form of collateral is based upon collateral possibilities with each ancillary line of credits.

For example, municipal cash flow for usage as collateral in the form of Direct Application Funding (DAF) could be a Parks Department cash flow involving the issuance of Park permits on a private basis by the lender as a result of a municipal default of the ancillary line of credit. This would be a transfer from the municipality managing of parks to being managed through resources of the debtor or lender to the municipality.

### Metes and Bounds

The metes and bounds of using a form of monetary collateral based on the DAF is structured to match line of credits for specific operating budget items. The combined line of credits lead to a primary line of credit which summates the ancillary tine of credits being offered. In this situation the form of collateral is based upon collateral possibilities with each ancillary line of credits.

The boundary of the Metes and Bounds of DAF would be structured to exceed the natural boundary of this situation which would be the total of principal and interest due on the loan because of the calculated probability of the components of the total loan amount should be exceeded by a minimum of 25% to assure the security of the total principal and interest originally lent.

### Steps for Type D: Direct Application Funding (DAF)

1. Direct Application Funding (DAF) involves a complete review of the operating budget of the municipality seeking to borrow funds from a lender.
2. Further review of the operating budget is then scrutinized for possible revenue sources of the municipality that can be designated as collateral in the event the municipality defaults on the loan from the lender for a DAF loan.
3. Revenue sources that can be utilized for this purpose are then allocated as collateral to loan or loans from the lender for the Direct Application Funding (DAF) loan.

### Type E: Master Leasing Collateral

In this form of collateral the lender or provider of funds establishes an agreement with the municipality that upon the event of a default of debt the lender has legally transferred from the municipality any and all leases that the municipality has in place. This is accomplished by the leases containing a special clause which, in the event of a default by the municipality, the lease is terminated to the original signer of the lease and then the lease is transferred to the secured lender of funds to the municipality under Master Leasing Collateral.

The lender has the option to accept or reject any leases that the municipality may have that are being transferred to the lender as collateral. The purpose of this form of collateral is to allow cash flow to continue to the lender even though the municipality has defaulted on the original loan to the municipality by the lender.

### Metes and Bounds

The Metes and Bounds of using a form o monetary collateral based on the leases containing a special clause which, in the event of a default by the municipality the lease is terminated to the original signer of the lease and then the lease is transferred to the secured lender of funds to the municipality under Master Leasing Collateral.

Here the Mets and Bounds is determined by the total payments of the life of the leases as compared to the total amount of original principal and interest of the loan. The boundary of this collateral is further extended by the necessity of an additional amount that would be due to the lender because of the Time Value of money which would be 10% per year over each year of the cumulative total of all the leases that were generated by default and reassigned to the lender.

### Steps for Type E: Master Leasing Collateral

1. Lender establishes an agreement with the municipality that in the event of a default by the municipality with the loan issued by the lender any and all leases of the municipality are legally transferred to the ownership of the lender.
2. The lender has the option to choose and reject ownership of any the leases of the municipality being used as collateral for the loan from the lender.
3. The purpose of the transfer of leases to the ownership of the lender is to allow cash flow for interest and principal payments to continue to the lender in the event of a default of the loan from the lender to the municipality.

### Type F: Monetary Collateral as Self-Issued Digital Currency

In this scenario the municipality or governmental structure launches a digital asset also known as a cryptocurrency which is to be used as collateral for the borrowing of funds and loans from private sources. This is a process of creating essentially Self-Collateral or collateral created by the borrower for obtaining loans from private and even public sources such as higher levels of government, for example a state lending funds to a local municipality would utilize the cryptocurrency created and launched by the municipality to provide a form of collateral for a loan.

If a loan made to the municipality is in default then the municipality's digital asset or cryptocurrency is transferred in ownership to the lender as collateral for the loan. We can note that in this case the municipality has a digital asset or cryptocurrency that has successfully launched and has sufficient market value to cover the defaulted loan in part or whole.

In this particular collateral the municipality should design, build and launch the proposed digital asset or cryptocurrency at least one year before utilizing the digital asset as a collateral for a loan. Ideally the digital asset could be attached to either silver, gold or other physical asset but this is not necessary. Once a market price can be established for the digital asset it can be resolved into a format useful a collateral for a loan.

### Metes and Bounds

The Metes and Bounds of using a form o monetary collateral based on the issuance of self-created digital currency by a municipality would have an Natural Boundary Contour based upon the economics of such transactions that are in place in situations where there is a borrower and a lender. By a Natural Boundary Contour we imply that the digital currency establishes a price per Coin by the traditionally law of Supply and Demand. Once a price is determined by the market factors of Supply and Demand of the Self-Issued Municipal Cryptocurrency and establishes a value the cryptocurrency can be offered to the Lender as a form of Collateral for the loan being proposed by the lender to the municipality. In this situation the Natural Boundary of the Metes and Bounds is an area equivalent to the total amount of the product of the principle and Interest of the loan from the lender to the municipality and geometrically would have an area equal to a rectangle by allowing the principal to be one side of the rectangle and the interest the second side in which area is equal to the product of multiplying the two sides or principle multiplied by interest to create a number which we term RECTI and can be used in the other forms of collateral also as a comparison number whereby the larger RECT is the greater is the cost of the loan to the municipality.

### Steps for Type F; Monetary Collateral as Self-Issued Digital Currency

1. The municipality creates and launches a special digital asset (cryptocurrency) to be specifically used as a collateral for a particular loan from a lender.
2. Ideally the municipality can use a valuable metal as backing for the digital asset such as gold or silver but this is not necessary.
3. Once the digital assets is launched it needs to attain a market value before being used as collateral for the loan from the lender.

### Type G: Direct Property Collateral

Direct Property Collateral involves the lender to a municipality having as collateral certain public property of a municipality. In this situation the public property is transferred to the lender upon default of the municipality on a loan. The property being used as collateral is pre-designated to be used as collateral in the event of a loan default by the municipality This is a direct transfer of property to the lender upon the default of a loan by the municipality. The pre-designated nature of the property is structured to have preliminary necessary approvals from any local or state authorities that are required to approve such a loan collateral.

### Metes and Bounds

The Metes and Bounds in this situation the public property is transferred to the lender upon default of the municipality on a loan. The property being used as collateral is pre-designated to be used as collateral in the event of a loan default by the municipality. This is a one to one relationship between the amount of principal and interest and the amount of this type of collateral to be utilized. In the situation the Natural Boundary of the Metes and Bounds is an area equivalent to the total amount of principle and Interest of the loan from the lender to the municipality and geometrically would have an area equal to a rectangle by allowing the principal to be one side of the rectangle and the interest the second side in which area is equal to the product of multiplying the two sides or principle multiplied by interest of create a number which we term RECT and can be used in the other forms of collateral also as a comparison number hereby the larger RECT is the greater is the cost of the loan to the municipality.

### Steps for Type G: Direct Property Collateral

1. Specific public properties owned by the municipality are appraised and then attached as collateral for a particular loan from a lender.
2. The public properties are free and clear of any other liens and are approved by appropriate state and local to be usable as collateral for private loans.
3. Upon default of a municipality for a particular loan the selected properties are legally transferred to the lender as collateral.
4. The municipality has the right to make offers to the lender who is now the owners of the public properties received in a default of the loan to repurchase the properties any time after 90 days when the properties were legally transferred to the lender.

### Type H: Reconversion of Vacant Public Property Collateral

In this form of collateral the lender has attached to the loan agreement selected public properties that the municipality offers as collateral which the lender can utilize to build residential or commercial building units. The municipality continues to own the selected properties and agrees to lease to the lender the property at a pre-determined fixed amount for an extended period of time such as 50 years with a renewable clause.

### Metes and Bounds

The Metes and Bounds of using a form of monetary collateral the lender has attached to the loan agreement selected public properties that the municipality offers as collateral which the lender can utilize to build residential or commercial building units. In this situation the Metes and Bounds present a natural boundary which would result in the replacement of the defaulted interest and principal payments in the form of of total RECT (as defined earlier) of the total specific properties RECT formula.

### Steps for Type H: Reconversion of Vacant Public Property Collateral

1. Attachment to loan agreement with lender selected properties that can be used by the lender for constructing residential or commercial units in event of a default of the loan between the the lender and the municipality.
2. In the event of a default of the loan between the lender and the municipality the municipality continues to own the vacant public property. The municipality agrees to lease the property to the lender in the event of a default in the loan between the municipality and the lender for an extended period of time for example 50 years with a renewable clause.

### SUMMARY

We have presented a number of unique methods of applying forms of collateral for loans by private lenders to municipalities and other forms of governmental structures such as states or national countries for the purpose of protecting interest and principal payments due from such loans to the lender in the event of a default of a loan by the municipality or particular governmental structure.

1. To provide unique and original methods of applying different forms of collateral for loans to municipalities currently not known or available and other forms of governmental structures from private lenders including the following forms of collateral: Collateral Transformation of Property to Lease Holdings, Public Property Structured as Public Corporate Domains (Dominion Collateral), Reverse Usage Bond (RUB), Direct Application Funding (DAF), Master Leasing Collateral, Monetary Collateral as Self-Issued Digital Currency, Direct Property Collateral and Reconversion of Vacant Public Property Collateral to protect the lender from a municipality defaulting on a loan by providing sources of funding to replace in whole or partially designated interest and principal payments due to the lender from the municipality of the defaulted loan.
